(19) United States
(12) Patent Application Publication
(10) Pub. No.: US 2007/0266156 A1
(43) Pub. Date: Nov. 15, 2007

(54) Contact management system and method

(76) Inventor: John T. Wilkins, Danville, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 11/713,475

(22) Filed: Mar. 2, 2007

Related U.S. Application Data
(63) Continuation-in-part of application No. 11/431,886, filed on May 9, 2006.

(51) Int. Cl. G06F 15/173

(52) U.S. Cl. 709/225

(57) ABSTRACT

A computer-implemented contact management method includes creating a contact record in a contact management system, generating a unique serial number corresponding to the contact record, conveying the serial number to a recipient, entering, by the recipient, the serial number into an internet-enabled computer application, and requesting, by the application, the record from the contact management system corresponding to the serial number. The contact record includes an indication of whether approval from the contact record owner is required prior to enabling the requester to access to the contact record. If approval is not required, then the requester receives data associated with the contact record. If approval is required, then the requestor is notified that access to the requested contact record is awaiting approval. If approval is granted, the requestor is granted access to the requested contact record. Otherwise, the requestor is notified that the contact request has been rejected.

### CROSS-REFERENCE TO RELATED APPLICATION

This application is a continuation-in-part of U.S. patent application Ser. No. 11/431,886, filed May 9, 2006, which is incorporated herein by reference.

### FIELD OF THE INVENTION

The present invention relates generally to contact management systems and, more particularly, to systems and methods for selectively disseminating personal contact information.

### BACKGROUND OF THE INVENTION

It is customary for individuals involved in personal, commercial or professional activities to exchange contact information with their associates. In a typical exchange, parties convey company names, personal names, job titles, telephone numbers, mailing addresses, e-mail addresses, web page addresses and other contact information. The mode of exchange usually includes stating the information verbally, writing down the information or exchanging business cards or stationery. Traditionally, people have recorded and organized contact information manually by writing contact information into an address book or by affixing a business card or a contact entry to a record keeping system such as Rolodex®.

Today's computer-based contact management applications provide powerful search and retrieval capabilities and user friendly application interfaces, which make it convenient for individuals to enter contact information into their personal computers. Contact management applications are also found on portable devices including cellular telephones, hand-held computers, VoIP (Voice over Internet Protocol) telephones, and web-based applications. Additionally, many businesses employ enterprise resource planning systems, customer relationship management systems, sales force automation systems and other systems having contact management functionality. As a result, a large number of contact management applications are available for personal and business use, and individuals regularly utilize more than one contact management application to store and maintain their contact information.

Entering contact information into multiple contact management applications requires a time-consuming and redundant manual data entry process. The high costs associated with manual data entry are well-understood, and many prior art systems have been designed to address these concerns. For example, creating an electronic backup file of a contact information database enables contact data to be automatically restored to a contact management application if the application's database becomes corrupt. Backup files also enable data from one application to be imported into another application, provided the file formats are compatible or translation from one format to another is feasible.

Some prior art systems were designed to minimize the burden of manually entering contact information through use of specialized hardware and software. In one approach, a business card scanner is used to scan the characters on a printed business card, and specialized Optical Character Recognition (OCR) software attempts to identify the scanned characters and assign the identified characters to appropriate data fields in a contact management application. These systems require the purchase of expensive hardware and software, and human oversight is needed to ensure accuracy of the recognized characters and placement of the data in the appropriate contact information field (e.g., the software may mistakenly assign a fax phone number to a voice phone number field). These scanning systems are typically adapted to work with personal computers and may not be compatible with small computing devices such as personal digital assistants (PDAs), handheld computers, and cellular telephones. These scanning systems are further limited to scanning printed business cards, thus contact information received through other conveyances (e.g., verbal or handwritten) will still require manual data entry.

In another approach, a Uniform Resource Locator (“URL”) for an HTML web page is encoded into barcode format onto a business card. A recipient of the business card scans the barcode into a web browser application to access a corresponding web page containing personal contact information. This type of system is described in Software Patent Institute Serial Number TDB0901.0055, entitled “E-Business Card System,” and Serial Number TDB1093.0202, entitled “Coded Business Cards.” Drawbacks of this approach include high equipment costs and the inability to use the system to input data into existing contact management applications.

Small, portable devices such as PDAs, handheld computers or cellular phones present additional problems for users needing to manually enter contact information. Cellular phones, for example, include numeric keypads in which a single key is used for entry of a number and multiple letters. As a result, a user may need to press the same key three or four times to select a desired letter or number. Many pen-based PDAs do not include a physical keypad, but instead provide the user with a “virtual” keyboard on the PDA display that may be tapped with a pen. Some small computing devices include a miniaturized keyboard, but data entry remains more challenging than using a full-sized keyboard on a typical desktop or laptop computer. Because of the difficulty in entering and managing data on small devices, many users manage contact information using a software application on a desktop computer. The contact information can be entered and viewed through the desktop application and then downloaded to compatible contact management applications on PDAs, handheld computers and cellular phones via a cable or wireless network transmission.

To facilitate the electronic exchange of contact information, the Internet Mail Consortium developed a specification for an electronic business card data structure called a “vCard.” Users typically exchange vCards as attachments to email messages. The recipient of a vCard may import the vCard data into a contact management application that supports the vCard format. Drawbacks of the vCard include the difficulty of maintaining up-to-date contact information once conveyed, and the lack of compatibility with traditional modes of conveyance such as a standard business card, which still requires manual input of contact information.

Web-based contact management applications have also been introduced, but these systems are not widely used due to drawbacks in the various approaches. In one approach, a subscriber enters contact information online, shares the information with other online subscribers, and may download other subscribers' contact information to a proprietary application. Among the drawbacks of these systems are the use of proprietary contact management software and the requirement that both parties be subscribers to the web-based system.

Another approach offers add-on modules to contact management applications in widely-adopted e-mail applications to assist in maintaining current contact information. Examples of this type of system are described in U.S. Pat. Nos. 6,694,353 and 6,701,348. In one approach, the contact management application notifies the user when the application sends an email message to a contact at an email address that is not valid. The stored contact information may then be updated using a secondary email address for the intended recipient. In another approach, a user of an email application transmits an email message to each member of the user's contact list requesting that each recipient verify the accuracy of the recipient's current contact information. One drawback to these approaches is that use is limited to certain software applications, such as Microsoft Outlook. Another drawback is that sending e-mails to recipients in a contact list may be inconvenient and annoying to the recipients. When a recipient's contact information is stored in multiple contact lists, the recipient may be inundated with email requests from the owner of each list to separately verify the recipient's stored contact information. Another drawback is that these systems require unique context-dependent identifiers for use in data lookup. Context-dependent identifiers include telephone numbers and email addresses. A user who lacks a required identifier cannot store and share contact information on these systems. Further, context-dependent identifiers are subject to change, for example, as the user moves or changes jobs.

### SUMMARY OF THE INVENTION

The present invention is a computer-implemented contact management system and method. One aspect of the present invention includes creating and storing a contact record in a contact management system, generating and storing a unique serial number corresponding to the contact record, and conveying the serial number to a recipient. The recipient may then enter the serial number into a network-enabled computer application and request, via the application, the corresponding record from the contact management system. In response, the application receives data associated with the contact record and stores the data in the application's database, or receives an indication that approval from the owner of the contact record is required before the contact management system will transmit the requested contact record.

In another aspect of the present invention, the recipient enters a serial number into a network-enabled computer application and requests, via the application, associated contact information from the contact management system corresponding to the serial number. The contact management system determines whether approval is required, and if so, responds to the recipient indicating that the request requires prior approval from the owner of the contact information. Following an approval of the request, the contact management system provides the user with a method to receive data associated with the contact information.

In another aspect of the present invention, a method for receiving data following a request for a contact record that requires owner approval prior to access includes the steps of automatically creating and storing a request record with a unique request serial number to identify the record. The date and time of the request is logged in the request record, and the requestor is prompted for additional information to be stored in the request record including the requestor's name and contact information (such as an e-mail address) and other information to facilitate the approval process, such as a contact ID or a note field for specifying the purpose of the request. Next, the user responsible for approving the request is notified and provided with an interface for approving or rejecting the request. The user who requested the contact information is provided with status updates of the approval process as needed. After the request is approved, the corresponding contact information is available to be received by the requestor.

A more complete understanding of the present invention will be afforded to those skilled in the art, as well as a realization of additional advantages and objects thereof, by a consideration of the following detailed description. Reference will be made to the appended sheets of drawings, which will first be described briefly.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates an embodiment of the present invention;

FIG. 2 illustrates an operation of the embodiment of FIG. 1;

FIG. 3 illustrates another operation of the embodiment of FIG. 1;

FIG. 4 illustrates an embodiment of a data structure for a contact request;

FIG. 5 is an embodiment of a contact reply message and an associated network device database record;

FIG. 6 illustrates an embodiment of a contact registry server;

FIG. 7 illustrates logical components of the contact registry server of FIG. 6;

FIG. 8 is a flowchart illustrating an embodiment of a process for sharing a group of contacts;

FIG. 9 illustrates data records stored in a contact registry database in accordance with an embodiment of the present invention;

FIG. 10 illustrates an embodiment of a network device;

FIG. 11 illustrates logical components of a contact application in accordance with an embodiment of the present invention;

FIG. 12 illustrates an operation of a synchronization process in accordance with an embodiment of the present invention;

FIG. 13 is a flowchart illustrating an embodiment of a synchronization process executed by a contact registry server;

FIG. 14 is a flowchart illustrating an embodiment of a synchronization process executed by a network device;

FIGS. 15a-b illustrate embodiments of a contact reply message and contact reply container, respectively;

FIG. 16 is an embodiment of an internal update message;

FIG. 17 is a flowchart illustrating an embodiment of an approval process; and

FIG. 18 illustrates an embodiment of an approval record.

### DETAILED DESCRIPTION OF PREFERRED EMBODIMENTS

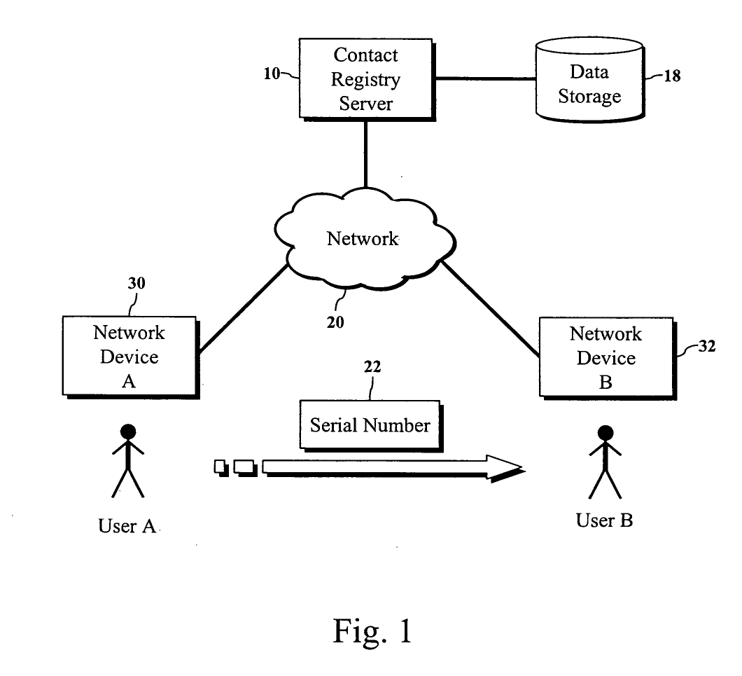

An exemplary embodiment of the present invention will be described with reference to FIG. 1. A contact registry server 10 provides contact management services to a plurality of network devices, such as network devices 30 and 32, through a network 20. The contact registry server 10 includes at least one computer adapted for communication with the network 20, and a data storage 18 storing contact information. The network 20 includes any system or systems capable of facilitating communications between the contact registry server 10 and the network devices 30 and 32 and, in various embodiments, may include the Internet, a wireless network or an intranet. Each network device 30 and 32 is adapted for communications with the contact registry server 10 through the network 20, and may include a mobile telephone, personal digital assistant, vehicle navigation system, personal computer, portable computer, VoIP telephone or other network-enabled device.

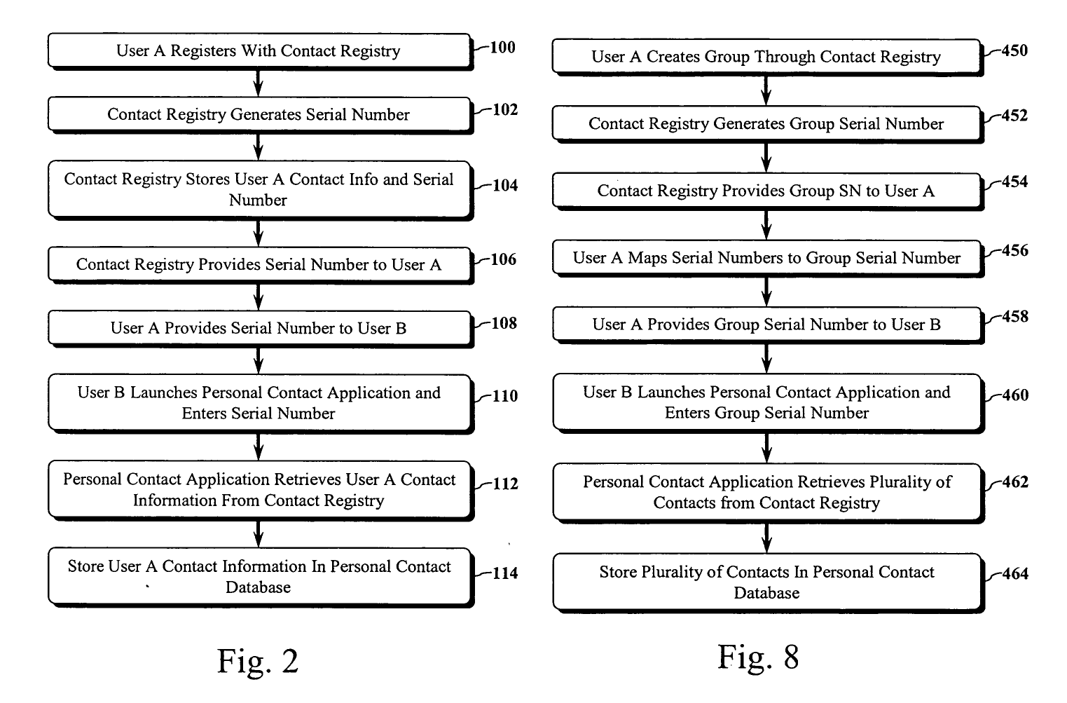

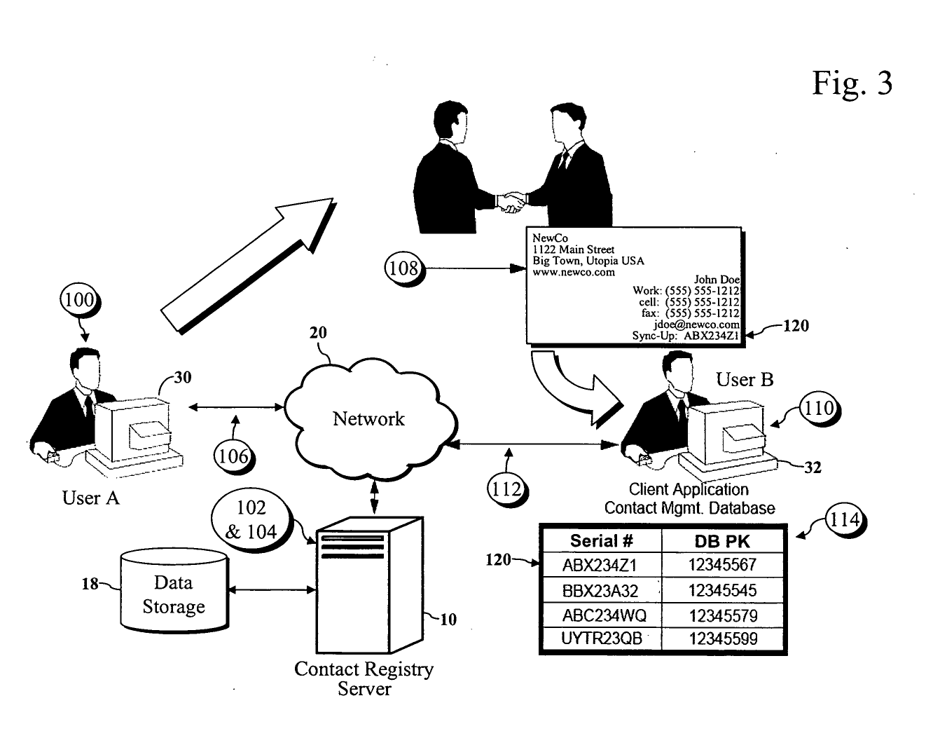

Referring to FIGS. 2 and 3, an operation of the embodiment of FIG. 1 will be described. In step 100, a first user, User A, registers with the contact registry server 10. Registration provides User A with permission to store, maintain and disseminate contact information via the contact registry server 10. In one embodiment, User A establishes communication with the contact registry server 10 through the network device 30 by launching a web browser application and entering or selecting a URL of the contact registry server 10. Through web pages served by the contact registry server 10 to the network device 30, User A invokes a new user registration process.

User A enters a unique username and password combination for use by the contact registry server 10 to identify and authenticate User A in subsequent visits to the web site. Alternatively, a temporary password is automatically generated by the contact registry server 10 and may be changed later by User A after the first login session. In one embodiment, communications between the network device 30 and the contact registry server 10 during the registration and login process are encrypted (e.g., using the Secure Socket Layer (SSL) protocol) providing a layer of protection against the unwanted access to or dissemination of personal contact information.

In step 102, the contact registry server 10 generates a unique serial number to identify User A's personal contact information. The serial number may be any unique identifier that is amenable for user input into a network device. In the exemplary embodiment, the contact registry server 10 randomly generates a 9-digit serial number, including a concise 8-digit alphanumeric string and a 1-digit alphanumeric error detection code, and queries the data storage 18 to ensure that the generated serial number is unique—i.e., is not already in use by the contact registry server 10 to identify personal contact information. Alternatively, the 8-digit serial number may be selected by the user, User A, and the contact registry server 10 generates an associated 9-digit serial number. An automatically generated serial number may incorporate naming conventions such as portions of the user's name and/or company name. User selected serial numbers and the generation of serial numbers in accordance with naming conventions result in serial numbers being potentially easier to remember.

Alphanumeric characters enable the contact registry server 10 to issue serial numbers with an extensive address space that can accommodate millions of users. For example, over 2.8 trillion serial numbers can be generated using only 8 digits of case-insensitive alphanumeric characters, where each character has 36 possible values (e.g., 0 through 9 and A through Z). Alternatively, the serial number may include characters from other character sets to accommodate different languages and cultures, including non-western character sets such as Kanji. In one embodiment, an extended character set known as the Unicode character set is used.

When User B enters a 9-digit serial number, the network device 32 can detect certain data entry errors by verifying the accuracy of the error detection code and notify User B when an invalid serial number is detected. The error detection code may be generated using conventional error detection algorithms such as CRC-8, a parity bit algorithm or other error detection algorithms.

After a unique serial number is generated, a filtering function may be applied by the contact registry server (CRS) to determine whether the serial number is valid based on stored criteria. In one embodiment, the data storage 18 includes a table of offensive words, phrases and character patterns that are utilized by the filtering function to determine whether the serial number includes a word or pattern of characters that may be deemed offensive. If the serial number is not valid, then a new serial number may be selected.

In step 104, a data record is created in the contact management database of data storage 18 for User A, and the unique serial number is stored therein. The record includes a field for the serial number and other fields that are common in contact management databases, such as name, address, telephone number and email address. In one embodiment, User A is provided an opportunity to populate the database record with personal contact information through a web browser interface. The contact registry server 10 may also store additional information, such as user account information and user preferences, including whether approval from User A is required before the contact registry server disseminates User A's contact information to third party requesters. In step 106, the contact registry server 10 communicates the serial number to User A via the web browser interface on the network device 30 or, alternatively, via another supported method of conveyance, such as an email message to User A.

In step 108, User A conveys the serial number 22 to User B. User A may print the serial number 22 on a business card and provide the business card to User B, type the serial number into an email message and send it to User B, verbally convey the serial number to User B or provide the serial number 22 through another mode of conveyance. In one embodiment, the serial number is conveyed, along with an associated trademark that identifies the source of the serial number 22 and the associated contact registry server 10. For example, User A may convey the serial number 22 in the form “SyncUp: JDOE25Z2C,” where “SyncUp” is a promoted trademark identifying the source of the number, making it clear what the number conveys. In this embodiment the number isn't just a serial number printed on a business card, displayed in an email or conveyed verbally; it is conveyed in association with a trademark to distinguish it from other serial numbers and addresses such as email addresses and phone numbers.

In step 110, User B enters the serial number into a contact management application on network device 32. In one embodiment, User B launches the personal contact management application on the network device 32 and creates a new contact record which includes a blank serial number input field identified by a common name or trademark. The personal contact management application is adapted to transmit an entered serial number to the contact registry server 10 and requests corresponding contact information associated with User A. User B can rely on the accuracy of the information entered into the contact registry server 10 by User A, which presumably has been verified by User A.

To protect against the unwanted dissemination of User A's unique serial number and contact information, the data may be encrypted before it is stored in the data storage 18. In one embodiment, the contact information is encrypted with a common encryption algorithm using User A's User ID as the public key and User A's confidential password as the private key.

In one embodiment, another security measure implemented by the contact registry server 10 includes detecting random serial number requests and invalid serial number requests, and denying access to users and/or network devices who attempt to access personal contact information without authorization from the user associated with the contact information. For example, a registered user of the contact registry server 10 may be denied access to the system after numerous failed attempts to enter a serial number. Invalid serial numbers may be detected, for example, if the entered serial number includes too many or too few digits, if the serial number has not yet been assigned to a user, or if an error detection code is invalid.

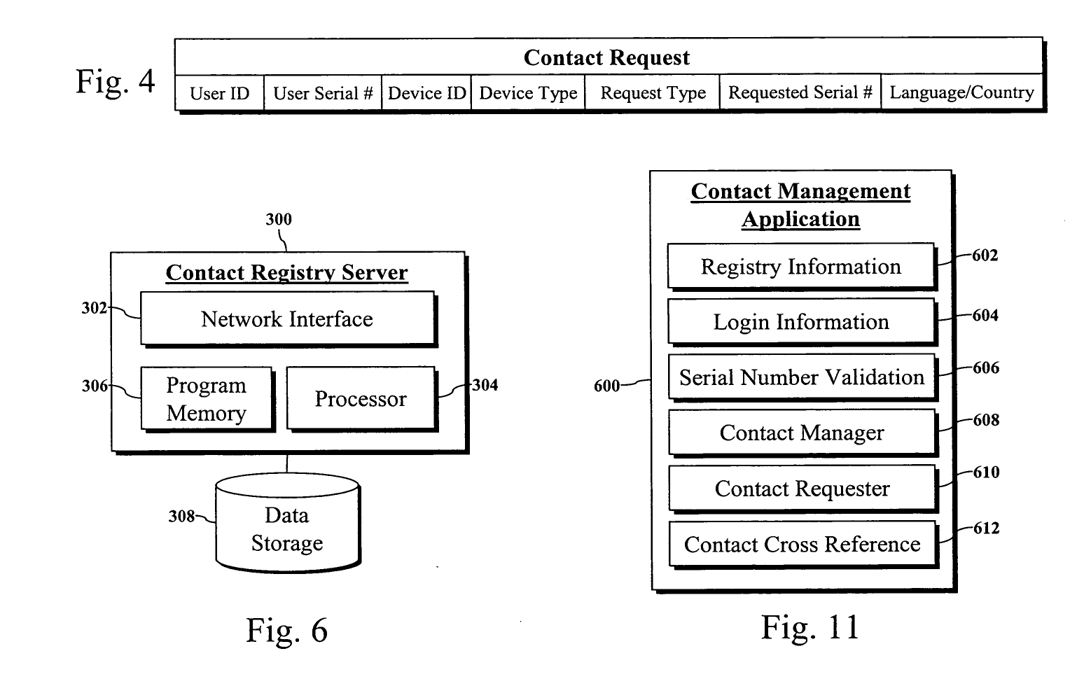

A message format for requesting contact information from the contact registry server 10 is illustrated in FIG. 4. The contact request is transmitted from the network device 32 to the contact registry server 10 and may include a User ID for authentication of the requester, a Device ID for logging and synchronization of stored contact information, a device type for identifying a data format or protocol associated with the network device 32, a request type indicating if the message is a request for a new record, an update, or a deletion (among other possible request types) and the requested serial number. In one embodiment, the contact request also includes a contact serial number of the requestor in order to associate the requested serial number with a particular contact serial number used by the requestor. In another embodiment, the contact request includes a category (e.g., work, home, personal) to associate the requested serial number with a request context.

In one embodiment, the contact request and contact reply further include a 4-digit or 5-digit identifier providing space in the request and reply for a 2-digit or 3-digit language abbreviation and a 2-digit country abbreviation. The 2-digit country code may be specified in accordance with International Standards Organization (ISO) ISO 3166-1 (e.g., US, UK, JP, etc.), and the language may also be specified in two digits in accordance with ISO 639-1 or three digits in accordance with ISO 639-2 (e.g., DUT: Dutch; ENG: English; FRA: French; JPN: Japanese.) Alternatively, the contact request and contact reply further include a character encoding in accordance with ISO 8859, UTF-8, UTF-16, ISO 2022, and others. For example, a request from a Russian-speaking user of a contact management application who resides in the United States may include the term “RUUS” (Russian+U.S.) or ISO 8859-5 (Cyrillic). In this manner, a subscriber doing business in different countries, across different languages, can convey serial numbers encoded in language character sets other than the Roman Alphabet, and the contact registry server 10 can correctly interpret the serial number. Additionally, the contact record may similarly be encoded in difference languages.

In one embodiment, a contact record is stored in a first language, such as English, and the contact registry server receives a request identifying the contact record, the request including a code for a second language code, such as Japanese. In this embodiment, the contact registry server is adapted to translate the stored contact record from the first language to the second language and return the contact record in a format associated with the second language code.

In another embodiment of the present invention, the contact registry server 10 is adapted to receive and transmit Short Message Service (SMS) communications. A request for a contact record including at least the unique serial number 22 may be transmitted from an SMS-enabled device, such as mobile phone, to the contact registry server 10. The contact registry server 10 includes logic to parse the SMS request, retrieve the contact record corresponding to the received serial number, and transmit an SMS message including the requested contact information in reply. The requested contact information may be transmitted as a vCard, unformatted text, or other predetermined format. In this manner, an SMS-enabled mobile device may be used to request and receive contact information from the contact registry server 10 without requiring modification of the software on the mobile device. In addition, SMS and vCard technologies are supported on most wireless devices worldwide, which would further reduce barriers to adoption of the present embodiment. Other communication protocols supporting the receiving and transmission of text messages over a network may be implemented in a similar manner.

In another embodiment of the present invention, a network device, such as a public switched telephone network (PSTN) landline telephone using SS7 or similar protocol, is adapted to transmit a request for contact information to the contact registry server 10 and receive a response containing the requested contact information or other messages using SS7 or a similar protocol. In one embodiment, a telephone network switch that supports SS7 is adapted to receive a request from a landline telephone and forward the request to the contact registry server 10. The telephone network switch is also adapted to receive a response from the contact registry server 10 and forward the response to the landline telephone that made the request. The contact registry server 10 is adapted to receive requests and transmit responses using SS7. In an alternate embodiment, the network switch is adapted to convert the SS7 request to a network protocol supported by the contact registry server 10 (e.g., TCP/IP, HTTP).

In alternate embodiments, an approval process limits access to User A's contact information by requiring prior approval before the contact information is disseminated in response to a user request. The approval process allows registered users to control the dissemination of their contact information, while maintaining a desired degree of privacy and confidentiality. In one embodiment, User A defines a set of approval criteria to be applied to one or more contact records by the contact registry server 10. After receiving a request for a contact record, the contact registry server 10 determines whether approval criteria has been specified for the contact record, and if so, will provide the requested information only after the approval criteria is met. For example, manual approval by User A may be required prior to releasing the requested contact information. While the contact registry server 10 awaits approval from User A, the contact registry server may respond with an “approval pending” message to User B. In other embodiments, approval criteria include user specified rules for automatic approval. For example, approval may be limited to requestors who are registered users of the contact registry server 10, to requestors whose contact information is stored in User A's address book, or other criteria specified by User A. User A may also set up approval levels that differ based on the content of the requested information. For example, User A may have business contact information that is publicly available, but require approval of home information.

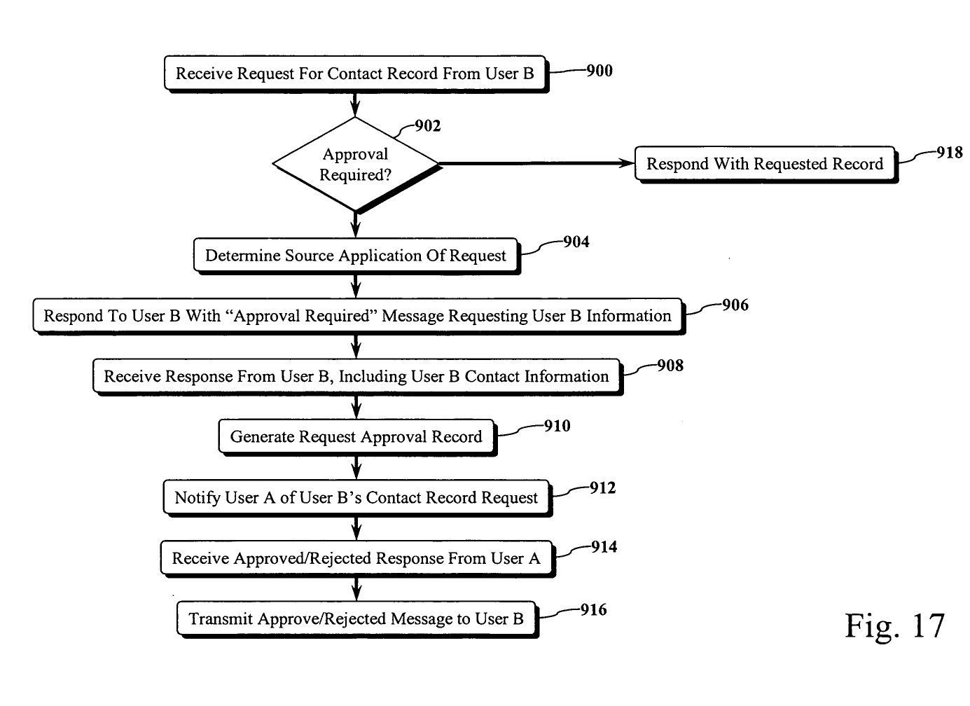

Referring to FIG. 17, an exemplary embodiment of a web browser-based approval process will now be described. In step 900, User B requests a contact record through a compatible end user application, such as by navigating a web browser application to the URL of a contact record request page. If approval is required, User A, must approve the request before the contact registry server 10 can release the contact record to User B (step 902), then the contact registry server determines the source application of the contact record request in step 904 and responds to User B with an “Approval Required” message in step 906. If no approval is required (step 902), then the contact registry server responds with the requested record in a format compatible with the requesting application in step 918—for example, via an XML message, via an email or SMS message, via an SS7 packet, or via a web page or a download for import into the requesting application.

In one embodiment, use of certain contact management services, such as a request for contact information, is provided to users without charging a fee for the service. Providing services for free may be desirable because it promotes rapid and widespread adoption of the contact management services. The contact registry service provider may collect revenue through the placement of targeted advertisements in messages and web pages (e.g., banner ads) transmitted to User B in response to requests for contact records or other service requests, such as contact record updates. The contact registry provider may collect additional revenue by offering premium services on a pay-per-use or subscription basis.

Similarly, the format of the ‘Approval Required’ message may be selected based on the source application. For example, if the contact registry server determines that the request originated from a contact record request web page associated with the contact registry server, the ‘Approval Required’ message may include a web page that informs User B that approval of User A is required. In one embodiment, this web page includes a name field identifying User B to User A, an e-mail field indicating an email address of where to send User A's contact information if approved, and other fields for collecting information from User B to assist User A in approving or rejecting the contact request such as a note field for use by User B to provide an explanation or purpose for the contact record request to User A, and a field for User B's contact information serial number enabling User B to provide his or her contact serial number to User A.

In one embodiment, User B enters his or her name, e-mail address, and other requested information into the Approval Required web page and submits the information to the contact registry server which receives the information in step 908. In step 910, the contact registry server generates a request approval record to track the request-approval process. An exemplary embodiment of an approval record is illustrated in FIG. 18. If User B's contact information is known to the contact registry server 10 (e.g., if User B is logged onto the contact registry server) or the network device (e.g., presence of a software cookie or a resident service module) then the contact registry server 10 can populate the fields of requested information on behalf of User B.

In step 912, the contact registry server notifies User A that there is a pending request that requires User A's approval. In one embodiment, the contact registry server sends an e-mail notification to User A. In another embodiment, the contact registry server notifies User A through an end user contact management application, such as upon login by User A onto the contact registry server or through a resident service module on User A's network device.

In step 914, User A approves or rejects (or possibly ignores) User B's request. In one embodiment, User A approves or rejects User B's request by logging onto the contact registry server, navigating to an approval/rejection web page, selecting User B's request record and pressing either an “Approve” or “Reject” user interface button. If User A approves or rejects the request, the contact registry server changes a ‘Request Status’ field depicted in FIG. 18 from ‘unapproved’ to ‘approved,’ or alternately from ‘unapproved’ to ‘rejected’ if User A rejects User B's request.

In step 916, the contact registry server transmits a message to User B indicating the result of the approval process. In one embodiment, if User A approves User B's request, an e-mail message is sent to User B including User A's contact information. The e-mail may include the contact information as unstructured text, as a structured text record attachment (e.g., XML or vCard), or in another format. In alternate embodiments, the e-mail message will include a URL or hyperlink to an approved request web page or a file that enables User B to retrieve the contact information from the contact registry server 10. The messages transmitted between the contact registry server and User B, including associated email and web pages, may further include advertising which generates revenue for the contact registry service provider. In an alternate embodiment, a network device adapted for communication with the contact registry server through an application plug-in receives the result of the approval process in a structured text record such as XML or vCard that is compatible with the requesting application.

Another embodiment of the present invention includes a taskbar service module on a Windows-enabled computer, which enables the user to activate a service module from a taskbar, make requests for contact information, and approve requests for contact information without the aid of an internet browser. A taskbar module provides a convenient way to access application functionality over the internet without requiring the user to open a browser, navigate to the application, provide authentication credentials, and navigate to the particular functionality the user wishes to exercise. Instead, the user may click on an icon on the taskbar to launch a contact registry service module that will maintain a session with the contact registry server. In one embodiment, the user may enter a serial number and request contact information through the service module, or approve requests for the user's information as necessary. The service module stores the username, password, and network address necessary to establish a connection to the contact registry server.

The service module further includes an application programming interface allowing contact management applications and plug-ins to access the contact registry server through the established session. The service module includes functionality to accept requests received through the interface from a contact management application, and provides common functions described herein. The use of a service module simplifies the development of contact management applications and associated application plug-ins and reduces the need to develop redundant functionality when numerous applications are supported for the same operating system.

Referring back to FIG. 2, after access to User A's contact information is granted to User B, in step 112, the contact registry server 10 retrieves User A's contact information—identified via the received serial number—from the data storage 18. The contact registry server 10 transmits the contact data (e.g., first name, middle name, last name, telephone number, e-mail address, etc.) in a structured information record, such as an XML file, suitable for mapping to data fields in User B's contact database. The format may be specified by User B's contact management application through a code in the contact request (e.g., in the device type field).

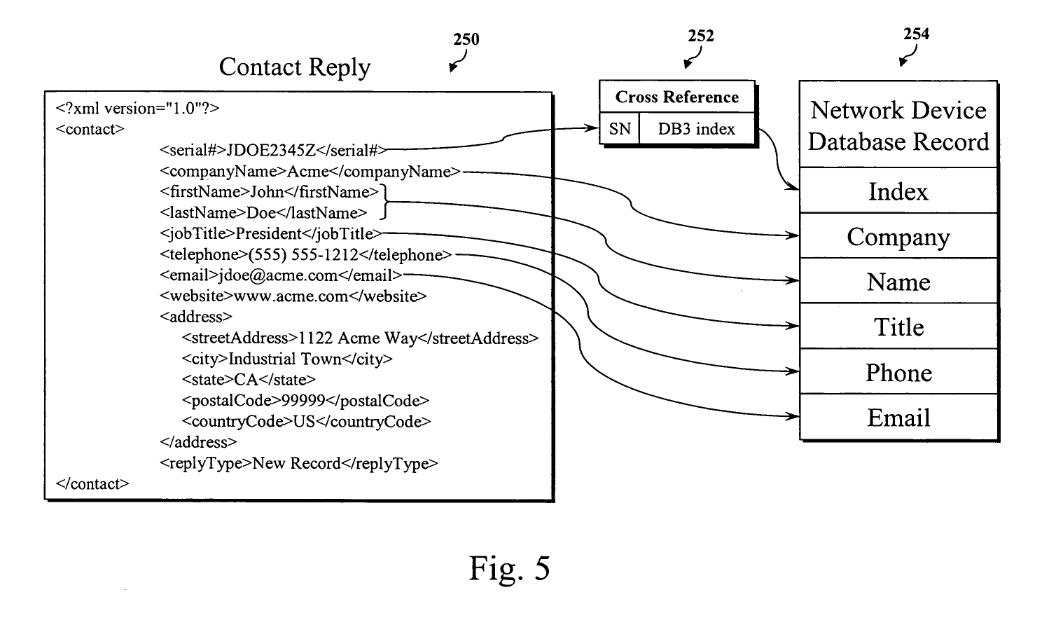

The received contact information is imported into User B's personal contact database in step 114. As illustrated, the conveyed serial number 120 is stored in a database table that at least includes an identifier of an associated contact record, such as a unique database record index or primary key. An example of a mapping from an XML-formatted contact reply message 250 to a network device database record 252 and cross-reference file 254 is illustrated in FIG. 5. In one embodiment, the received contact data is entered as a new record and the serial number is stored in a cross-reference file along with the record ID or index of the new record within the contact management application. The cross-reference file facilitates a link between the contact data stored on each network device and the corresponding data stored in the contact registry server, which is useful for updates, synchronization (i.e., the delete requests) and other linked requests.

Advantages of the present embodiment will be readily understood by persons having ordinary skill in the art. For example, in the present embodiment, a contact record is stored in a centralized database, and includes a unique, context-free serial number. A concise context-independent serial number (e.g., not an e-mail address associated with an email account or a telephone number associated with a residence, etc.) is useful for conveyance, contact information requests, and creating a cross-reference between the contact record stored in the data storage 18 and a database index of the network device 32's contact management application.

Unlike a context-driven ID such as an e-mail address or telephone number, a user does not typically need to change the context-independent serial number over time, avoiding a break in cross-reference links that often occur (e.g., when a person changes jobs). In this manner, the context-independent serial number is associated with a trademark making it more easily conveyed. Using alphanumeric characters for the serial number makes it possible to issue short serial numbers amenable to user input that identify an extensive address space. By contrast, a conventional contact record has over 100 characters, each of which requires entry under a manual input system. The present embodiment also makes it possible to synchronize many different types of devices and applications, allowing a user to maintain consistent, up-to-date contact information across many different devices.

In one embodiment, the contact registry server 10 is adapted to automatically synchronize a plurality of personal contact databases associated with a user. The contact registry server 10 logs each request for contact information from each network-enabled application. When one of the network-enabled applications sends a synchronization request to the contact management system, the requesting application will automatically receive contact information, deletion instructions or other information requested by other network-enabled applications associated with that user.

In another embodiment, the contact registry server includes a service providing for the remote deletion of contact information stored on network devices and applications. For example, if a user discontinues the use of an application, or if a network device is lost or stolen, the user may wish to delete the associated contact information on that device and block future contact registry requests from the application or device to prevent misuse of the stored information. In operation, a registered user of the contact registry server initiates the remote deletion service and identifies the applications and devices targeted for contact information deletion. The contact registry server logs the identified devices and applications and prevents future contact requests thereby. The deletion of the remote contact information may be implemented through the update and synchronization features described herein (e.g., by identifying the remote records as deleted or updated as blank records) or by adapting the contact registry server to transmit deletion instructions to one or more of the network-enabled applications that support remote deletion of contact information.

In another embodiment, the contact registry server provides a search field(s) enabling a requester to submit a person's name, telephone number, e-mail address or other criteria and retrieve an associated serial number(s). The contact registry server optionally enables registered users to specify whether other users may search for their record by name, telephone number, e-mail or other criteria to prevent undesired access.

In one embodiment, a contact record may be requested through a hyperlink to a contact registry server 10 request page, including at least one search parameter. For example, a signature block in an outbound email may include a hyperlink to the contact registry server 10 request page along with the sender's contact serial number. An email recipient may make a contact record request by clicking the hyperlink.

An email application may be further adapted to parse incoming emails using a common protocol such as POP 3 to search for contact serial numbers attached to or included in an e-mail. If the email application locates a serial number, it may determine via a cross-reference file if the application already has requested the serial number. If the application hasn't requested the serial number, the application may present a dialog box offering to make a request, and the user may accept or reject the offer. If a contact serial number is not found in an incoming email, the email application may alternatively issue a search request to the contact registry server 10 using other identified criteria, such as the sender's email address or contact information identified by parsing the incoming email.

### Contact Registry Server

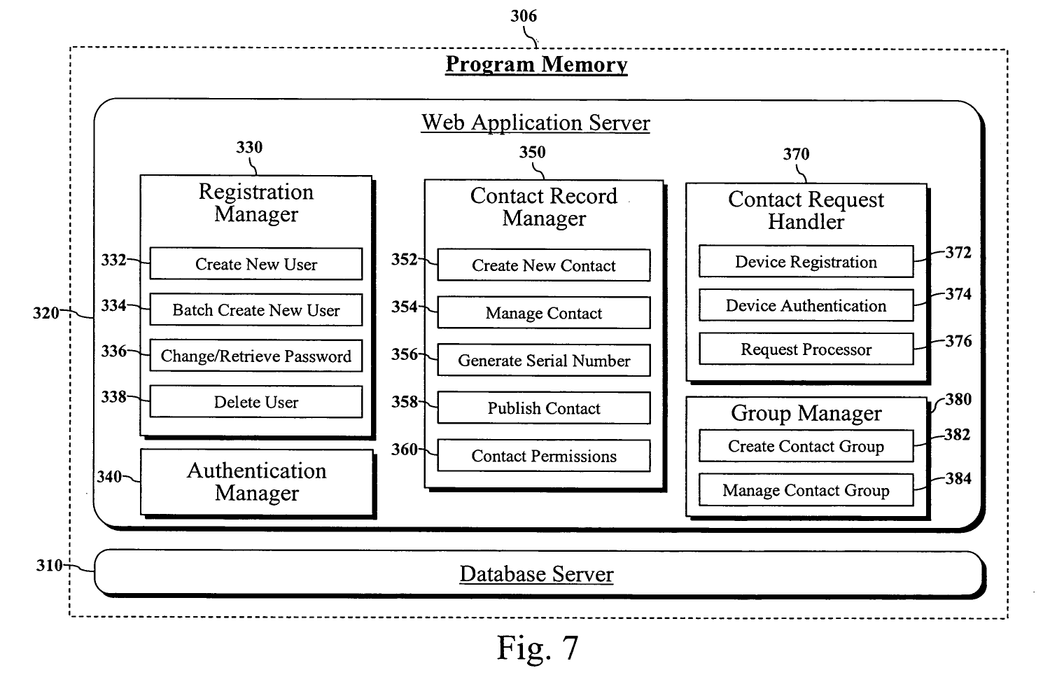

An embodiment of a contact registry server 300 will now be described with reference to FIGS. 6-9. The contact registry server 300 includes a network interface 302 to facilitate communications with network devices, a processor 304, and a program memory 306 that includes logic for instructing the processor 304 to facilitate the creation, storage, maintenance and retrieval of contact information in a data storage 308.

The program memory 306 of the exemplary embodiment includes a database server 310 and a web application server 320. The web application server 320 includes a registration manager 330 for handling user registration, an authentication manager 340 for authenticating users and devices accessing the contact registry server 300, a contact record manager 350 for handling the creation, storage and updating of contact information, a contact request handler 370 for delivering contact information to requesting network devices, and a group manager 380 for handling group creation and management.

The registration manager 330 includes processes for creating a new user 332, creating a plurality of new users through a batch process 334, changing/retrieving a password 336 and deleting users 338. In one embodiment, these processes may be invoked by a user of a network device through a web page interface or via the interface of a contact management application.

In another embodiment, the “new user” batch process 334 invokes the contact record manager 350 to create a plurality of contact records simultaneously. The batch process includes receiving, at the contact registry server 300, a batch of input data consisting of contact information for a plurality of users. The batch process creates new users and generates batch output data, including the user ID, the temporary password, and the serial number, as well as information from the batch of input data (e.g., an e-mail address or a mailing address) that will assist in disseminating registration data to the newly registered users. The contact record manager 350 generates the serial number for each contact record and creates a new record to link the user ID and the contact record's serial number. Invalid batch data can be logged and returned to the requestor in a report. The batch input and output data could come from a file, a database, a network or other source. A person having ordinary skill in the art will appreciate that a batch process may reduce the effort associated with registering a plurality of users simultaneously, such as the employees of a large corporation.

The delete users process 338 includes both single delete and batch delete capabilities. In one embodiment, a large entity such as a mobile telephone provider or Internet Service Provider (ISP) offers access to the contact registry server as a value-added service bundled with other offerings. The batch delete would be used by large entities when access to the systems changes on a regular basis and may be part of standard integration of the contact registry service to the large entity.

The contact record manager 350 includes program logic for creating a new contact 352, managing contacts 354, generating serial numbers 356, publishing contacts 358, and managing contact permissions 360. In one embodiment, the logic for generating serial numbers 356 includes a pattern recognition algorithm to filter out serial numbers including offensive or otherwise undesirable sequences of digits. The user provides contact information through the contact record manager 350 which stores the contact information in the data storage. Personal contact information may be input and updated through a web page interface. The contact request handler 370 includes device registration 372, device authentication 374 and request processor 376 functions.

Once a user completes the registration process and changes the assigned temporary password, the contact record may be published, which makes it possible for network devices to request the contact record. Next, the user may set contact permissions for the contact record, which makes it possible for the user to deliberately authorize or refuse each request for the contact record, or to automatically approve or reject requests.

The contact permissions process 360 restricts access of third-party users and network devices to particular contact records. When a contact record is published, the contact information is available for retrieval by any user who enters the corresponding serial number. Through the permissions feature, a user may manually approve each request for the user's contact information, automatically approve each request, or establish rule-based conditions for approving access to the contact data. For example, the user can deny the provision of contact information to anonymous requesters. Referring back to FIG. 1, when User B requests User A's contact record, the system can generate a response to User A indicating that it is awaiting approval from User A to release the requested information to User B. This would spawn follow-up requests for the record (if approved), a refusal message (if the request is rejected), or a “still waiting” message.

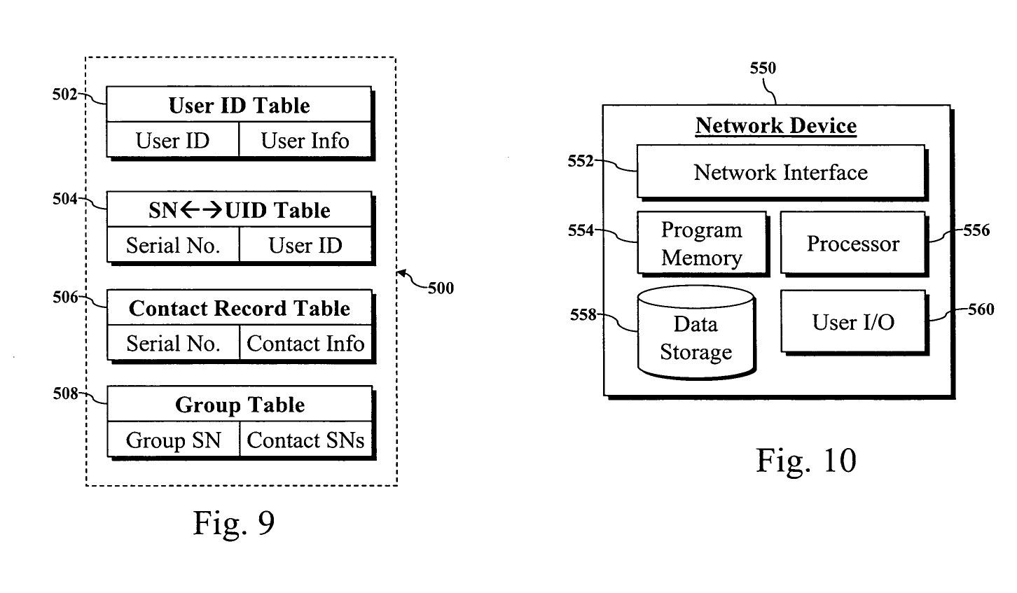

In one embodiment, a plurality of contact serial numbers, such as those belonging to company employees, may be grouped under a single group serial number. A group serial number is assigned by the contact registry server 300 and mapped to a plurality of existing contact serial numbers or group serial numbers in a group database 508 (see FIG. 9). Further, a network device requesting contact information associated with a group serial number will receive a plurality of associated contact records in response. The group manager 380 includes program logic for creating a contact group 382 and managing contact group 384. In one embodiment, the generate serial number function 356 is adapted to generate a serial number for the group, and the request processor 376 is adapted to process group requests and replies.

Referring to FIGS. 1 and 8, an embodiment of the operation of group serial numbers will be described. User A establishes a contact group through an interface on the contact registry server 10 in step 450. The contact registry server generates a unique group serial number in step 452 and transmits the group serial number to User A in step 454. In step 456, through a second interface on the contact registry server 10, User A enters one or more serial numbers of potential group members. The group members may be referenced by individual contact serial numbers and group serial numbers which are mapped to the group serial number managed by User A. In one embodiment, the contact registry server 10 requests approval to include individual contact or group serial numbers in the group, as required. In step 458, User A conveys the group serial number to a third party, such as User B, to disseminate contact information for the group of users.

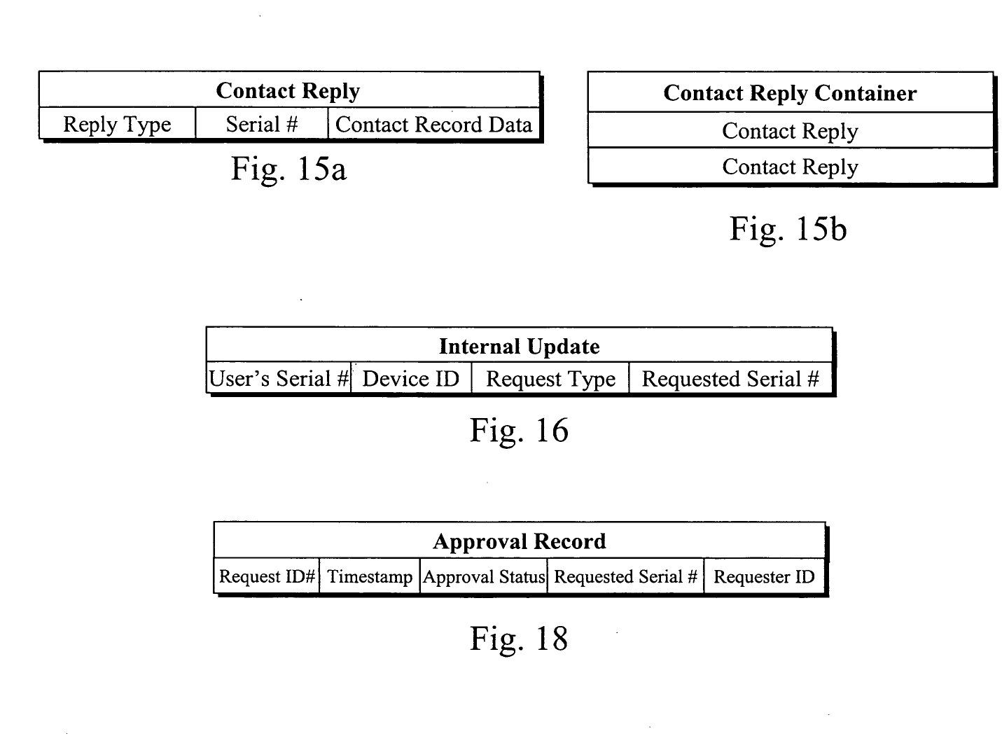

In step 460, User B launches a personal contact management application and enters the group serial number. In step 462, the personal contact management application retrieves individual contact information associated with the entered group serial number from the contact registry server 10. The contact registry server 10 receives the group serial number from the personal contact management application and retrieves the corresponding contact records from the database. The group of individual contact records are transmitted to the personal contact management application, such as through a contact reply container (see FIG. 15b). It will be appreciated by those having ordinary skill in the art that the plurality of contact records (each of which may include more than 100 characters) associated with the group may be retrieved by entering a concise serial number saving a significant amount of time and effort. In step 464, each of the received contact records is stored in the personal contact database. In one embodiment, the personal contact management application maintains a mapping of each contact record to its individual serial number, and each individual serial number to the group serial number.

A high-level data structure for storing contact information is illustrated in FIG. 9. The data structure 500 includes a User ID table 502 storing information for registered users, including a User ID and user information. In one embodiment, user information includes an account password and billing information, and may include additional data used by the contact registry server 10. A second table 504 maps serial numbers to user IDs, allowing the system to track the user associated with each contact record, and allowing a single user to maintain contact information under multiple serial numbers. For example, it will be appreciated by those having ordinary skill in the art that a single user may have a plurality of contact records to accommodate multiple languages (e.g., English, French or Japanese), countries and uses (e.g., business and personal). A contact record table 506 stores user contact information and an associated serial number. User contact information may include name, title, address, telephone numbers, email address, company name, web site, and other information.

### Network Device

An exemplary network device 550 is illustrated in FIG. 10. The network device 550 may be any device adapted to communicate with the contact registry server 300, such as a personal computer, a personal digital assistant (PDA), a wireless phone, a VoIP phone, a landline phone (e.g., using SS7 protocol), or another type of network-enabled device. The network device 550 includes a network interface 552, providing access to the contact registry server 300 through the network, a program memory 554 and processor 556 for controlling the network device 550, a data storage 558 and a user input/output mechanism 560, such as a display and keyboard.

Referring to FIG. 11, the program memory 554 includes a contact management application 600 which includes, or is enhanced with, registry information 602 and login information 604, which enable the contact management application 600 to access the contact registry server 300. A serial number validation function 606 checks the validity of a serial number format entered by a user. In the exemplary embodiment, the serial number validation function 606 verifies that the serial number entered by the user is a 9-digit alphanumeric string and that the error detection code is accurate. A contact manager function 608 provides an interface allowing a user to add, edit, delete and view a plurality of contacts. A contact requester function 610 enables a user to request contact records from the contact registry server 300. The contact requester 610 retrieves the network address of the contact registry server 300 from the registry information 602, generates a request message and transmits the message to the contact registry server 10 via the network device's network interface 552, the network 20, and the contact registry server's 300 network interface 302. A contact cross reference function 612 maintains a cross reference table mapping the serial numbers of retrieved contact records to the contacts stored by the network device.

In an alternate embodiment, the program memory 554 includes one or more network-enabled applications. For example, a graphics design application, such as Adobe Illustrator or Adobe InDesign, may include enhancements in the form of a plug-in allowing the application to receive a serial number, contact the contact registry server 10, and retrieve associated contact information. Through a graphics design application, the user may create a graphic that includes graphic variables. Entering the serial number into the menu for the application plug-in will cause the graphic variables to be set in accordance with the current associated contact information. An employer could use this feature to manage and print business cards, or a printing company might operate as a retail point of sale for the service. When the user updates data, the graphic variables will update automatically.

In another embodiment, the serial numbers of the exemplary embodiment may also be used to aid the completion of online forms. For example, User A may register with a plurality of web sites, with each web site having its own registration screen seeking personal information from User A. Affiliated web sites may include a serial number input field allowing User A to complete the contact information aspects of the form merely by entering his serial number. The web site benefits by ensuring it maintains current customer data, and enticing new users due to the simplified registration process. In some applications, the serial number may be used for user authentication allowing the user to protect his email address (and limit spam) and reduce the risk of providing credit card information over the Internet (e.g., ID theft). Further, the contact registry server tracks who has access to the contact registry information, allowing the user to track web sites to which the user is a member and allows the commercial web sites to maintain current contact information for the user.

The serial numbers of the exemplary embodiment may be used anywhere that contact information is requested, including in commercial transactions. For example, User A may contact a customer service call center, or desire to facilitate a commercial transaction such as purchasing merchandise, renting a car, registering for a hotel room, or booking an airline flight. When contact information is requested through a web-based contact request screen, a field for entry of a contact registry serial number simplifies the contact information request process, allowing the remaining contact fields to be populated automatically with corresponding contact information received from the contact registry server. A customer service representative, whether via telephone or in person, may input a serial number from a user into an application adapted for communication with the contact registry server 10 to retrieve all required contact information from the contact registry server in lieu of manual data entry. Organizations benefit through the use of the serial number by reducing the amount of data entry required to acquire demographic information, including reducing the risk of repetitive stress injuries. Organizations also benefit by ensuring accurate data entry, and by receiving periodic updates to the contact information as customer contact information changes.

In another embodiment of the present invention, a commercial application suitable for creating electronic forms, such as Adobe Acrobat, may be adapted for communication with the contact registry server 19 to retrieve contact information from the contact registry server and populate the fields of the electronic form. In another example, a serial number may be embedded into a PDF, allowing the PDF to be updated as corresponding contact information changes. This embodiment may be used with employment forms, tax forms, loan applications, health care forms, and other forms that utilize software suitable for creating or editing forms, such as Adobe Acrobat.

Serial numbers may also be used to facilitate mapping, navigation and GPS-related services. In one embodiment, a user seeking directions between two addresses can enter the serial number for the source location and the serial number for the destination location (in contrast to entering two complete addresses) into a compatible internet mapping or navigation system to retrieve the desired directions. Up-to-date contact information can be provided to any Internet-enabled device, ensuring that the two contact addresses are current. Many wireless devices are GPS and Internet enabled allowing users to request real time and location-specific information for the wireless device. For example, a wireless device can determine its current GPS location and identify local services such as the closest movie theater and current movie times. Contact information for such establishments may include an associated contact serial number, allowing the establishment's contact information be easily added to a user's contact address book and the user to receive contact information updates. In one embodiment, an application on the GPS/Internet-enabled device is adapted to display serial numbers along with establishment contact information, and add the serial number to the user's contact management application upon user request. In another embodiment, the contact registry server includes a reverse lookup function that retrieves a current GPS location or address, and returns the identities, contact information and serial numbers of the closest publicly available contacts satisfying user-selected criteria (e.g., restaurants or movie theaters).

The contact registry server and compatible network applications may further include information retention services that are adaptable to an individual's or entity's document retention requirements. When a contact management application requests an update from the contact registry server and the contact registry server provides an updated contact record, the original contact information will be lost unless saved by the requesting application prior to the update. This poses a potential problem to a corporation having a document retention policy that requires such information to be retained for a certain period of time, or to an entity that is involved in public policy or litigation and may be required to preserve electronic information. In one embodiment, a contact request history is maintained by the service module in accordance with user preferences that may include identification of records to store in the history, corresponding data fields that should be stored, and the specification of a “delete after” date (e.g., delete after 5 years).

In another embodiment, the contact information includes substantive content for use by a network-enabled application. For example, a contact record may include a graphic or logo, audio data, or specify a certain font style associated with the contact information that will control the look and feel of material printed through the network-enabled application.

In another embodiment, the contact registry server is provided as an add-on service to the services offered by cellular networks or internet service providers for a nominal fee per subscriber. Revenue may be generated by charging users for information retrieval using such services.

### Synchronization & Updates

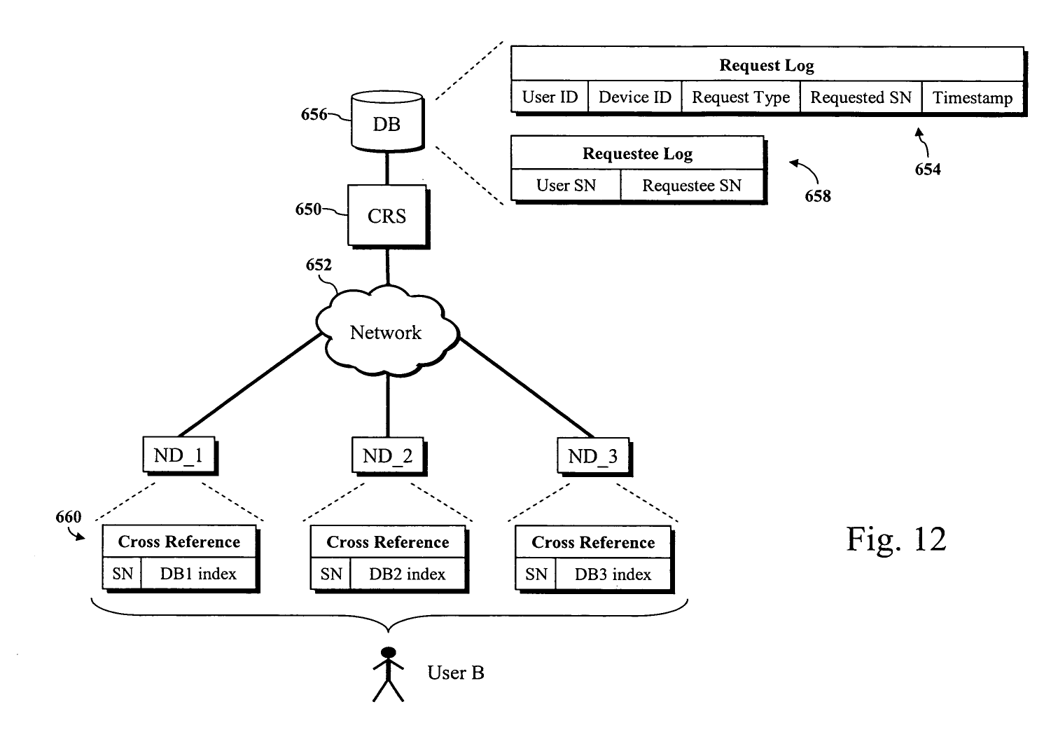

Referring to FIG. 12, in one embodiment, User B operates a plurality of network devices ND_1, ND_2 and ND_3, such as a personal computer, mobile phone and PDA device. In operation, User B enters a serial number in a first network device ND_1, which transmits a contact request message to a contact registry server (CRS) 650 through a network 652. The CRS 650 returns a contact reply to ND_1 including the requested contact information. The CRS 650 also creates an entry in a request log 654 in the database (DB) 656, logging the time the contact request from ND_1 was processed. ND_1 receives the requested contact information from the CRS 650 and stores the received contact information locally in a memory or other data storage associated with the ND_1.

The request log 654 tracks contact information requests and may include a user ID, a device ID, a request type, the requested serial number, and a timestamp for the request. The user ID uniquely identifies the requesting user and may include one of the user's personal serial numbers assigned by the CRS 650, a login name or other identifier. The device ID uniquely identifies the requesting network device, and in one embodiment a unique identifier is provided in each copy of the network device software before it is deployed on a network device. The CRS 650 may associate a request log with one of the requesting user's contacts when the request log includes the serial number for the requesting user's contact. In this manner, a user with more than one serial number, for example, a work serial number and a personal serial number, may manage the synchronization of separate contact lists. In another approach, the network device software requests a unique identifier from the CRS 650. Alternatively, the MAC address associated with the network device hardware may be used. Identifying each device facilitates the synchronization of contact records across multiple devices. For example, if a person requests a contact record with one device, another network device can request the same record without additional user effort.

The request type includes a code identifying whether the received request is for new contact information, an update to existing contact information, a request to delete contact information associated with User B or other type of request. When User B requests User A's serial number, the contact information is received and may be inserted as a new record into User B's contact management database. User B may later re-request User A's serial number, in which case the contact information is received, the corresponding contact record is located and the stored contact information is updated with any changes. User B may also issue a request to delete User A's contact information, which causes the contact information record to be deleted from the contact management database. Each of these requests corresponds to common database functions that may be implemented in this manner.

Initially, the requested contact information (stored on ND_1) is not stored on network devices ND_2 and ND_3. User B may separately enter the serial number into the contact management applications of ND_2 and ND_3 to retrieve the contact information from the CRS 650. In one embodiment, the network devices ND_1, ND_2 and ND_3 include a synchronization process that is automatically invoked when the respective network device contacts the CRS 650 with a contact request. The network devices may also be configured to periodically (e.g., daily, weekly, monthly, etc.) invoke the synchronization process to regularly check for updates. Further, it is contemplated that a user may manually invoke the synchronization process through the contact management application when desired.

The request log 654 enables User B to initiate a synchronization request to the contact registry server 650 from a network device to download new contact information, remove deleted contact information and update modified contact information. In this manner, User B is not required to reenter contact serial numbers into each device. In one embodiment, the log's timestamp is used to limit synchronization to records that have been added, updated or deleted since the device's last synchronization request. The network device may be identified through a device ID and the request log stores the timestamp of the last synchronization for each device ID.

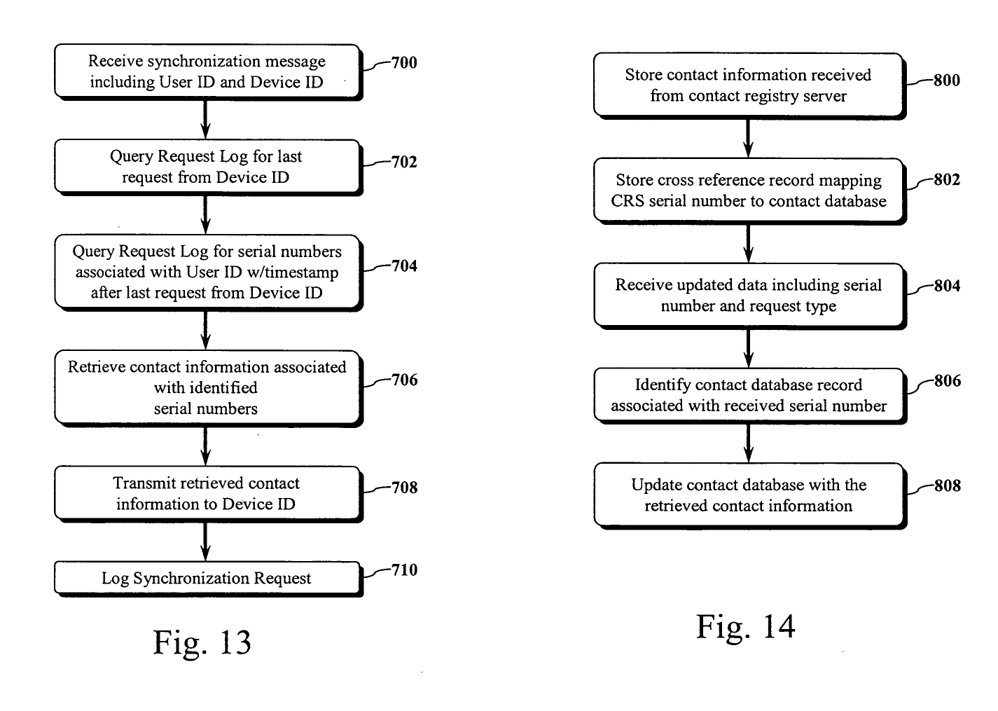

Referring to FIGS. 13 & 14, the synchronization process will be described. When the synchronization process is invoked, a synchronization request message, including the user ID and device ID, is transmitted from the ND_2 to the CRS 650. In one embodiment, the request message also includes a serial number associated to a contact of the requesting user. The CRS 650 receives the request in step 700 and queries the Request Log 654 to find the last time that ND_2 contacted the CRS 650 in step 702. In step 704, the CRS 650 retrieves all the request types and serial numbers from the request log entries associated with requests by User B subsequent to ND_2's last communication with the CRS 650, which may be measured by a timestamp field in each entry or some other serial field. In step 706, the CRS 650 retrieves the contact information for each serial number (not needed for request type “delete”) and generates contact reply messages to transmit the contact information to ND_2 in step 708. In this case, since User B entered User A's serial number in ND_1, there is a request log entry for User A's serial number. When ND_2 transmits a synchronization request, it receives User A's serial number and contact information from the CSR 650 in the reply. Finally, in step 710, the synchronization request from ND_2 is added to the Request Log 654, along with a current timestamp.

The network device ND_2 updates the contact information stored on ND_2 in accordance with the received request type. In the exemplary embodiment, a serial number/database record cross-reference table facilitates the update of contact records. An embodiment of an update process with a cross-reference table will now be described with reference to FIG. 14. When User B enters a serial number into the contact management application of a network device, a request is transmitted to the CRS 650, which returns associated contact information. A new contact record is created in the local contact information database and the received contact information is stored (step 800). When a new contact record is created, the contact management application assigns a local record identifier (or database index), which is stored as part of the record. In step 802, an entry in a cross-reference database 660 is added, mapping the local record identifier to the serial number associated with the contact information.

The cross reference table allows the contact management application to update contact records with information stored at the CRS 650. For example, a single contact record stored on ND_1 can be updated by querying the cross-reference table for the associated local record identifier, identifying the associated contact serial number and specifying the contact serial number in an update request transmitted to the CRS 650. In step 804, contact information is received from the CRS 650, and the contact serial number is used to retrieve the local record identifier from the cross-reference table in step 806. Next, in step 808, the contact record associated with that local record identifier is requested from the contact management application. The contact record stored on the network device may then be updated with new information (or deleted as required).

The contact records are updated according to the received “request type” associated with the contact information. Request types include “new record,” “update” and “delete” (among other possible request types). When a network device ND_3 synchronizes its contact information with the CRS 650, a “delete” request from ND_1 will be invoked, and during synchronization the contact reply to ND_3 will have a “reply type” of “delete” and the associated serial number. The contact record associated with the received serial number is then deleted from the contact information database and the cross-reference database.

In one embodiment, when records are added and then subsequently deleted before synchronization can take place, program logic at the contact registry server does not include the records in the replies to avoid unnecessary work by the network device. In another embodiment, the contact registry server further includes an approval log so that synchronization requests do not require User B to approve subsequent requests for every single network device that User A uses. For example, if User A has the serial number of User B, User B may have the option to disallow subsequent requests or updates from User A by removing User A from the Requestee log until User B approves the request subsequently.

An exemplary contact reply data structure is illustrated in FIGS. 15a-b. A contact reply message includes a reply type, serial number and contact information fields. A plurality of updates may occur between sessions and the reply message may have more than one contact reply. To accommodate multiple contacts in a reply message, a contact reply container includes at least one contact reply message and facilitates the transmission of reply messages as a batch. A single contact reply container may include reply messages having different types, such as a contact record or a message to the user (e.g, “awaiting approval”).

In one embodiment, when sending a reply message to the network device, the message is encrypted in a common encryption protocol such as MD-5, using the user's User ID as a public key and password as a private key. Using encryption for messaging and storage makes it more difficult for unauthorized users of the contact registry server to gain access to information by eavesdropping, “sniffing” or “spoofing” packet-switched network connections.

Referring back to FIG. 12, in one embodiment a requestee log 658 is used to track and control access to user records. When User B requests User A's contact information, for example, a new record is added to the requestee log 658 that indicates that User B has User A's contact information. As illustrated, the “user's serial number” is the serial number for User A and serves as a primary key in the database, and the “requestee serial number” is the serial number for User B. When User A makes a change to his or her contact record, the contact manager sends an internal update to each user linked to User A through the requestee log. The internal updates may be maintained in a database table such as that illustrated in FIG. 16. Where an internal update table is used, records are retrieved as part of the user's synchronization and converted to an entry in the request log to be downloaded the next time User B accesses the CRS 650.

Having thus described various embodiments of the present invention, it should be apparent to those skilled in the art that certain advantages of the within described system have been achieved. It should also be appreciated that various modifications, adaptations, and alternative embodiments thereof may be made within the scope and spirit of the present invention.

What is claimed is:

1. In a network including a contact management system and a plurality of network devices, a computer-implemented contact management method comprising the steps of:
receiving from a first network device a request for a contact record, the request including a serial number of the requested contact record;
searching a contact database of the contact management system for the contact record associated with the serial number;
determining whether approval is required prior to enabling access to the requested contact record; and
if approval is required, transmitting a notification of the required approval to the first network device.

2. The method of claim 1 wherein the request is a Short Message Service (SMS) message.

3. The method of claim 1 wherein the first network device is a public-switched telephone and the request is transmitted using the SS7 protocol.

4. The method of claim 1 further comprising the steps of:
transmitting a contact lookup page to the first network device;
receiving a lookup request from the first network device, the lookup request including a contact record query;
transmitting to the first network device the serial number of at least one contact record from the contact database that satisfies the query.

5. The method of claim 1 wherein the received request includes a Uniform Resource Locator (“URL”) directed to a contact lookup page, the URL including the serial number.

6. The method of claim 1 further comprising the steps of:
notifying an owner of the requested contact record of the request; and
receiving an indication from the owner of either an approval or rejection of the contact record request.

7. The method of claim 6 wherein the notification to the owner of the contact record request includes an identifier of the requestor.

8. The method of claim 7 further comprising the steps of:
if the contact record request is approved, enabling the contact record requestor to access the requested contact record; and
if the contact record request is rejected, transmitting a rejection notification to the contact record requestor.

9. The method of claim 1 wherein the notification includes an advertisement targeted to the requester.

10. The method of claim 8 wherein the rejection notification includes an advertisement targeted to the requester.

11. In a contact management system including a contact database, a method comprising the steps of:
creating a contact record in the contact database;
generating a unique serial number and storing the unique serial number in the corresponding contact record;
conveying the serial number to a recipient;
storing an indication of whether contact information associated with the unique serial number requires approval before being released to a requestor;
receiving through a network a request for the contact information, the request including the unique serial number; and
transmitting a reply message to the requester, the reply message including a conveyance of the contact information associated with the unique serial number only if no approval is required or if approval criteria is met.

12. The method of claim 11, wherein the requestor is a network-enabled device and communications between the network-enabled device and the contact management system are facilitated through the Internet.

13. The method of claim 11, further comprising the steps of:
notifying an owner of the requested contact information of the request for approval; and
receiving an indication from the owner of either an approval or rejection of the contact information request.

14. The method of claim 13 wherein the notification to the owner of the requested contact record includes an identifier of the requester.

15. The method of claim 14 further comprising the steps of:
if the contact information request is approved, enabling the contact information requester to access the requested contact information; and
if the contact information is rejected, transmitting a rejection notification to the contact information requester.

16. The method of claim 11 wherein the step of storing further comprises the step of establishing approval criteria for the contact record.

17. The method of claim 16 wherein the approval criteria includes rules for an automatic approval process.

18. The method of claim 16 wherein the approval criteria includes manual approval by the contact information owner.

19. In a computer-implemented contact management system, a method comprising the steps of:
requesting a contact record from the contact management system, the request including a unique serial number corresponding to the contact record;
receiving notification from the contact management system that the request requires approval before access to the contact record will be granted;
transmitting requestor information to the contact management system for storing in a request log; and
receiving the requested contact record.

20. The method of claim 19 further comprising the step of receiving a status update from the contact management system including a status of the approval process;

21. The method of claim 19 wherein the requester information includes a requestor identifier.

22. The method of claim 19 wherein the requestor information includes a name of the requestor and contact information for the requester.

23. The method of claim 19 wherein the requestor information includes a note field for indicating a purpose of the request.

24. The method of claim 19 further comprising the step of prompting a requestor to enter the requestor information into a network-enabled device.

25. In a network having a contact registry server and at least one network device, a contact management application for the network device comprising:
a service module including:
a session function adapted to establish and maintain a communications session with the contact registry server;
a contact information request and retrieval function adapted to receive a contact serial number, to request from the contact registry server contact information associated with the contact serial number; and to retrieve the associated contact information from the contact registry server; and
an application interface for receiving data from and transmitting data to an application on the network device, and for receiving instructions from the application to be executed by the service module.

26. The contact management application of claim 25 further comprising:
a cascading delete function adapted to receive a deletion instruction from the contact registry server and delete from the network device the contact information received from the contact registry server.

27. The contact management application of claim 25 further comprising:
a history function adapted to store an update history of the contact information stored on the network device.
